(19) United States
(12) Patent Application Publication
(10) Pub. No.: US 2003/0151245 A1
(43) Pub. Date: Aug. 14, 2003

(54) Print media advertising apparatus and method

(76) Inventors: Richard G. Levine, New York, NY (US); Barbara Smith Stark, Forest Hills, NY (US); Cindy Schreibman Pakula, New York, NY (US)

Correspondence Address: KRAMER LEVIN NAFTALIS & FRANKEL LLP, INTELLECTUAL PROPERTY DEPARTMENT, 919 THIRD AVENUE, NEW YORK, NY, 10022, US

(21) Appl. No.: 10/335,178

(22) Filed: Dec. 31, 2002

Related U.S. Application Data
(60) Provisional application No. 60/345,623, filed on Jan. 2, 2002.

(51) Int. Cl. G09F 1/00

(52) U.S. Cl. 283/56

(57) ABSTRACT

An advertising apparatus and method utilizing a sheet of pre-cut removable and repositionable page marking stickers insertable into a magazine or other publication. The individual page markers can selectively include advertisements printed on the bottom surfaces of the markers, which include adhesive, as well as on the sheet surfaces underlying the page markers. Advertisements printed on the underside of a page marker (including under the adhesive) and on the associated portion of underlying sheet may directly or indirectly relate to or correspond to one another, and are exposed when the marker is peeled from the underlying sheet to mark a page of interest in the magazine for later reference. The advertisement on the marker is highly visible when the marker is used to mark a page. The advertisement on the exposed underlying sheet is visible whenever that page is open.

### CROSS REFERENCE TO RELATED PROVISIONAL APPLICATION

This application claims the benefit of U.S. Provisional Patent Application No. 60/345,623 filed on Jan. 2, 2002.

### BACKGROUND OF THE INVENTION

The present invention is directed generally to a new apparatus and method for advertising in printed publications, such as, for example, magazines, using sheets of pre-cut removable and repositionable page marking stickers insertable in the magazines or other publications. More particularly, the present invention relates to an advertising apparatus and method wherein various advertisements can be printed on the underside adhesive surfaces of the page markers and on the sheet surfaces underlying the markers, the advertisements printed on the underside of each page marker and on the underlying sheet preferably being related to or corresponding to one another, and being exposed when the marker is peeled from the sheet, e.g., to mark a page of interest for later reference.

U.S. Pat. Nos. 5,011,189, 5,056,824, 5,249,827, 5,518,273 and 5,911,442 describe embodiments of a publication reference aid system in the form of detachable labels. Individual labels are initially attached to an inside page or the outside surface of a printed publication and each label is removable along a scored line between the label and a tongue portion permanently glued to the publication. Each label may be torn from the publication along the scored line and, through the use of a releasable adhesive strip provided on the label, adhered to a page within the publication. Before doing so, a separate covering page or covering strip must be removed to expose the adhesive. The labels can receive printing including under the adhesive on the liner covered by the covering strip. The labels include page markers as well as a separately mountable directory or index for the page markers. Indicia printed on the directory serves as a key for the indicia printed on the page markers.

U.S. Pat. No. 5,332,265 describes embodiments of an advertising assembly including removable and repositionable “tape flags” of the type commonly used to mark documents for signature. The tape flags can receive printing thereon.

U.S. Pat. No. 5,413,384 describes a label for use in couponing. Coupons are formed from a label material layer to which a release liner is releasably adhered. The top and underside of the label receive printed indicia, as does the top surface of the underlay material. The top surface of the label includes the coupon offer and a scannable bar code imprinted thereon. The underside of the label includes the terms and conditions of the coupon offer. The top surface of the underlay material includes a message that, when exposed, indicates that the coupon has been removed.

U.S. Pat. No. 5,507,901 describes a method of manufacturing integrated labels wherein a sheet of paper is provided with linear sections of release coating and pressure sensitive adhesive divided by a line of demarcation. The pressure sensitive adhesive area is folded over the release coating along the line of demarcation and later cut into individual labels or sheets.

U.S. Pat. Nos. 6,217,078 and 6,331,018 describe various embodiments of label sheets. Each label sheet includes an overlay sheet having pre-cut labels and an underlying release liner. The underside of the overlay has a high adhesion surface and the top surface of the liner is covered by a release layer having a low adhesion surface. The overlay and the liner can receive printing on both the front and back sides thereof, including under the release layer.

U.S. Pat. Nos. 6,257,623 and 6,349,970 each describe a method of manufacturing a printed publication having integrated removable and repositionable bookmark labels. Characters are printed onto a moving web of material, a release coating is applied to a portion of the moving web, an adhesive coating is applied to the moving web, the web is folded between the release coating and the adhesive coating to form a layer on top of a second layer, the top layer is cut into individual book marks, the moving web is cut into individual pages, and the individual pages are then bound together.

While a degree of attention has been paid to the manufacturing of page markers, the use of such markers for advertising has not been fully developed or appreciated. The present invention is directed to a new and unique application of page markers in print media advertising.

### SUMMARY OF THE INVENTION

Generally speaking, the present invention provides an apparatus and method for advertising in a printed publication, such as, for example, a magazine, utilizing one or more sheets of pre-cut removable and repositionable page marking stickers bound in the publication. A sheet of page markers includes a face sheet or overlay and an opposing release sheet. A relatively low adhesion adhesive is selectively provided on the bottom surface of the overlay for adhering the overlay to the release sheet.

The page markers are defined by pre-cut sections of the overlay, and are removably attached to the overlay. The adhesive is provided over only a portion of the bottom surface of the pre-cut page markers, thereby leaving an adhesive-free portion available to be grabbed by the reader: In use, the markers are individually peeled away from the underlying release sheet and used to mark a page of interest in the publication for later reference.

Advertisements can be placed on either or both the adhesive bottom surfaces of the page markers and the release sheet underlying the markers. Messages and/or advertising can also be printed on the top surfaces of the individual page markers as well as on the bottom surface of the release sheet.

Advertisements printed on the underside of a marker and the associated underlying release sheet preferably relate to or correspond to one another and are exposed when the marker is peeled from the page. Any advertisement and/or message on either surface of the marker is highly visible when the marker is used to mark a page. Any advertisement on the exposed release sheet is visible whenever that page is open.

It is accordingly an object of the present invention to provide a high impact advertising tool and reference aid for print media that is easy to use.

It is another object of the present invention to provide a magazine advertising apparatus and method employing removable and repositionable page markers used to mark pages for later reference.

It is also an object of the present invention to provide a magazine advertising apparatus and method including a sheet of pre-cut removable and repositionable page marking stickers bearing advertising on both the stickers and on associated portions of an underlying release sheet.

It is additionally an object of the present invention to provide a magazine advertising apparatus and method in which advertising provided on pre-cut removable page marking stickers relates to or corresponds with advertising provided on associated portions of the underlying release sheet.

Still other objects and advantages of the present invention will in part be obvious and will in part be apparent from the specification.

The invention accordingly comprises the several steps and the relation of one or more of such steps with respect to each of the others, and the apparatus embodies features of construction, combinations of elements, and arrangement of parts which are adapted to effect such steps, all as exemplified in the following detailed disclosure, and the scope of the invention will be indicated in the claims.

### BRIEF DESCRIPTION OF THE DRAWINGS

For a fuller understanding of the invention, reference is had to the following description, taken in connection with the accompanying drawings, in which:

FIG. 1 is a perspective view of a paginated publication of a type suitable for use in connection with the apparatus and method according to the present invention;

FIG. 2 is an enlarged top plan view of a sheet of page markers from the publication depicted in FIG. 1 arranged and constructed in accordance with the present invention;

FIG. 3 is an enlarged cross-sectional view taken along line 3-3 of FIG. 2 illustrating the removal of a page marker from the sheet of page markers depicted in FIG. 2 in accordance with the apparatus and method of the present invention;

FIG. 4 is a partial enlarged top view of the sheet of page markers depicted in FIG. 2 showing the release layer with advertising exposed as a result of two page markers having been removed from the sheet in accordance with the apparatus and method of the present invention;

FIG. 5 is an enlarged cross-sectional view of the sheet of page markers depicted in FIG. 4 taken along line 5-5 of FIG. 4;

FIG. 6 is an enlarged view of the underside of a page marker with advertising that has been removed from a sheet of page markers in accordance with the apparatus and method of the present invention;

FIG. 7 is a partial enlarged top view of a page from the publication depicted in FIG. 1 shown marked with a page marker in accordance with the apparatus and method of the present invention; and

FIG. 8 is an enlarged cross-sectional view of the page marked with a page marker depicted in FIG. 7 taken along line 8-8 of FIG. 7.

### DETAILED DESCRIPTION OF THE PREFERRED EMBODIMENTS

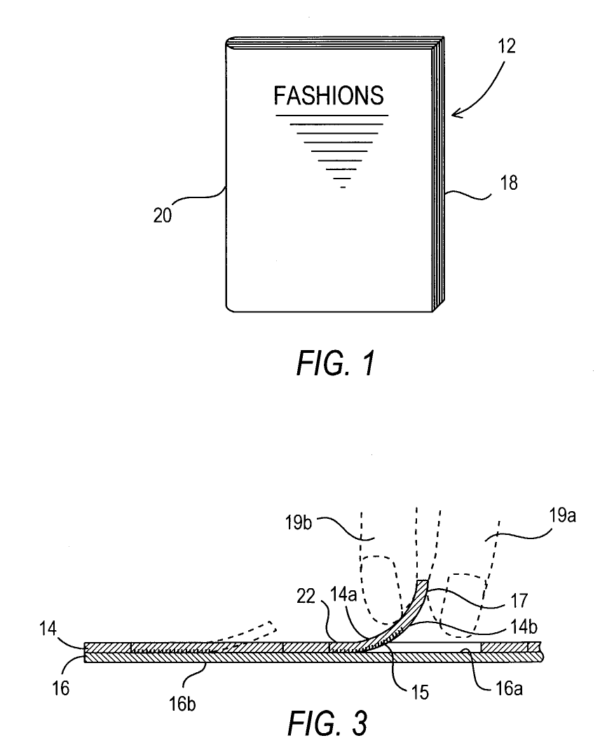

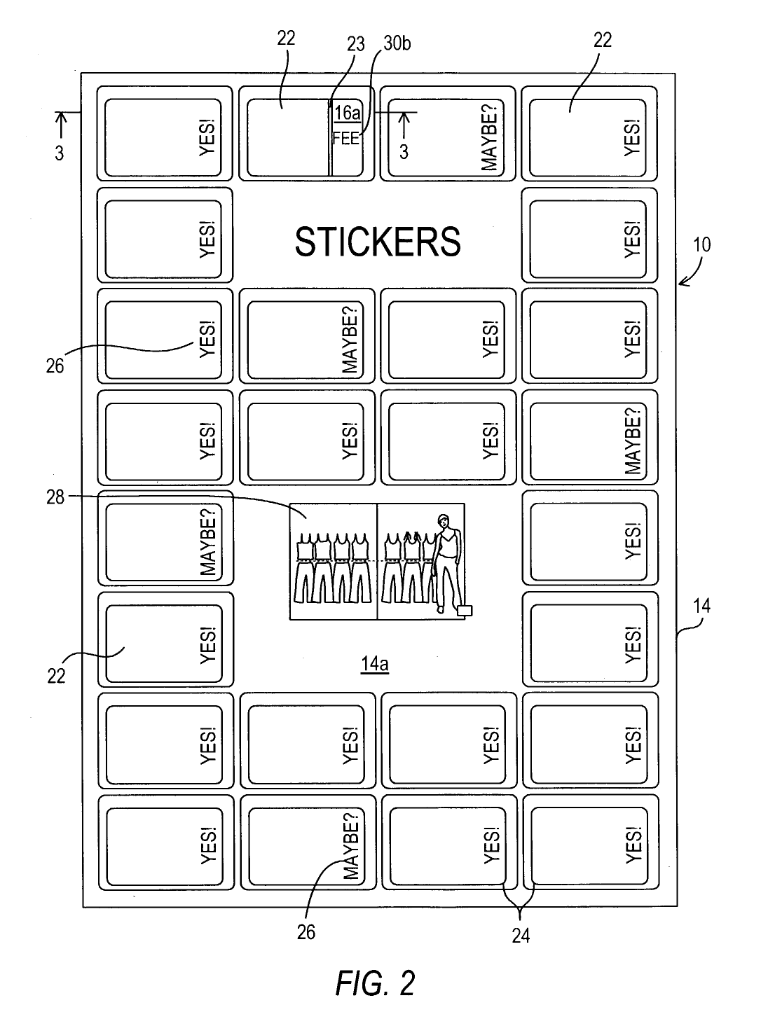

Referring to the drawings, where like reference numerals indicate like elements, FIG. 2 depicts a sheet, shown generally at 10, adapted to be included or bound in a printed publication, such as, for example, a magazine 12 as depicted in FIG. 1. Sheet 10 includes a face sheet or overlay 14 including a top surface 14a and a bottom surface 14b (FIGS. 3, 6 and 8). Bottom surface 14b of overlay 14 is selectively coated with a relatively low adhesion adhesive 15 to enable the overlay to be adhered to an underlying release sheet 16 (FIGS. 3 and 5) at a top surface 16a. Overlay 14 is depicted in sectional view in FIGS. 3 and 5 adhered to release sheet 16.

Preferably, overlay 14 and release sheet 16 are formed from a single sheet of paper or sheet stock, and folded over such that bottom surface 14b of the overlay faces and aligns with top surface 16a of the release sheet. In this arrangement, overlay 14 and release sheet 16 form a common edge proximate an outer edge or face edge 18 of the pages of magazine 12 (FIG. 1); the opposing open edges of the overlay and release sheet being joined together at a binding 20 of the magazine. Desirably, the size of the folded sheet formed by overlay 14 and release sheet 16 is smaller in width that the other pages of magazine 12 so that, as the magazine is trimmed to final size, the common edge of overlay 14 and release sheet 16 is not cut and therefore is not at risk of peeling apart at edge 18 of the magazine as a reader turns pages.

Additionally, the single sheet formed by overlay 14 and release sheet 16 can also be extended to include a facing sheet (two visual pages when printed front and back). As will become apparent from the detailed discussion that follows regarding the removable and repositionable page markers according to the present invention, this extended single sheet arrangement protects the page markers from pre-releasing or popping from the release sheet as the page marker page is fed through magazine binding equipment. A benefit of having one continuous sheet deliver a four page unit with removable pre-cut page markers is that production can be performed all in one pass through the press, reducing the cost.

It should be understood that the paper or sheet stock used for overlay 14 and release sheet 16 can be different from the paper or sheet stock used for the pages of magazine 12. Moreover, overlay 14 and release sheet 16 can each be formed from different paper or sheet stock.

It should also be understood that overlay 14 and release sheet 16 need not take the form of a single sheet, so long as the overlay and release sheet are positioned such that bottom surface 14b of the overlay faces and aligns with top surface 16a of the release sheet.

As depicted in FIG. 2, overlay 14 includes one or more removable stickers or page markers 22 pre-cut (e.g., die-cut, perforated etc.) therein. Page markers 22 can have any suitable shape or configuration, such as the rectangles illustrated. Desirably, page markers 22 are spaced apart from one another on overlay 14—separated by border regions 24.

Directly under each page marker 22, bottom surface 14b of overlay 14 is preferably only partially coated with adhesive 15, thereby leaving an adhesive-free portion 17 available to be grabbed by fingers 19a and 19b or other means. As depicted in FIG. 3, this arrangement permits individual human removal or peeling of page marker 22 from release sheet 16 along the pre-cut perimeter 23 of the marker for repositioning anywhere within magazine 12 (or other location) for later reference as described herein.

Desirably, top surface 16a of release sheet 16 is not provided with adhesive to prevent sheet 10 from sticking to a preceding page of magazine 12 when one or more page markers 22 have been removed.

Graphics or other indicia can be printed on top surface 14a of overlay 14. As depicted in FIG. 2, top surface 14a of those regions of overlay 14 defining page markers 22 preferably include messages 26, such as, for example, the recitations “YES!” or “MAYBE?” printed thereon. Top surface 14a of those regions of overlay 14 not defining page markers can include other indicia such as, for example, a graphical illustration 28 of how to use page markers 22 in accordance with the advertising apparatus and method of the present invention as described herein.

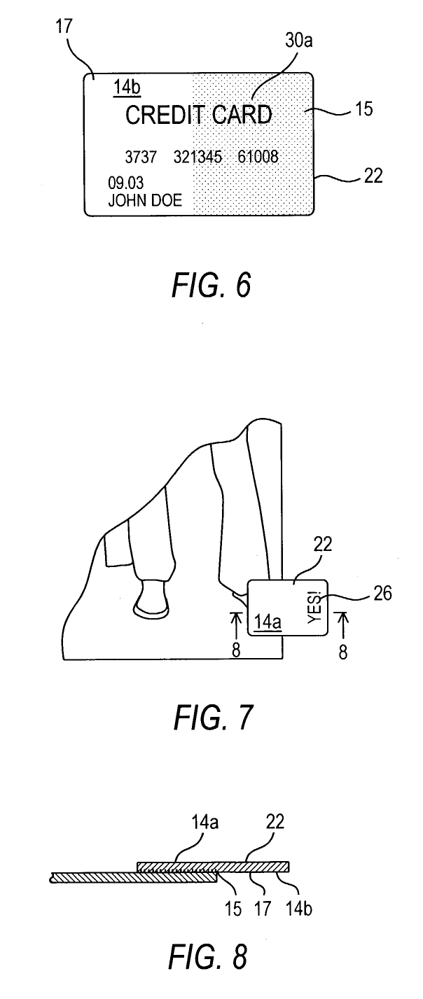

Preferably, each page marker 22 includes an advertisement 30a (in text, graphic or other form) printed or otherwise provided on the underside thereof under the partial adhesive coating 15, and extending, if desired, to the adhesive-free portion 17. FIG. 6 depicts an example of the bottom surface 14b of a page marker 22 including a representative credit card advertisement printed thereon under the partial adhesive coating 15 and on the adhesive-free portion.

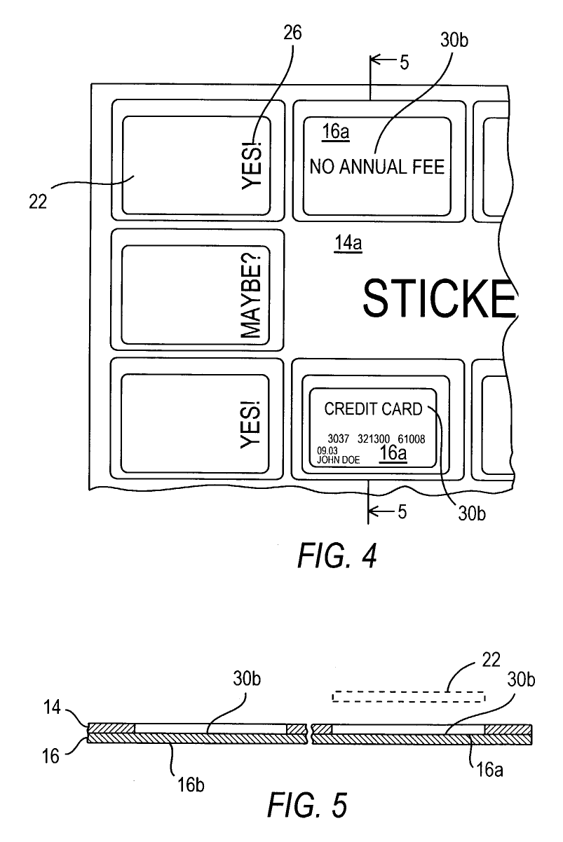

Additionally or alternatively, the top surface 16a of release sheet 16 directly underlying a page marker 22 can include an advertisement 30b (in text, graphic or other form) printed or otherwise provided thereon. FIGS. 4 and 5 illustrate portions of top surface 16a of release sheet 16 exposed (after page markers 22 have been peeled therefrom—see FIGS. 2 and 3) to reveal representative credit card advertisements printed thereon.

Preferably, if both a page marker and its associated underlying portion of release sheet include advertisements printed thereon, the content and/or appearance of such advertisements will relate to or correspond to one another (i.e., either directly or indirectly). By way of example, the credit card advertisements on each of the exposed portions of top surface 16a of release sheet 16 depicted in FIG. 4 include credit card advertisements printed thereon which directly and indirectly relate to or correspond to the credit card advertisement on bottom surface 14b of the page marker 22 depicted in FIG. 6—one advertisement shown in FIG. 4 being a copy of the advertisement shown in FIG. 6, the other advertisement in FIG. 4 referring to the credit card advertisement in FIG. 6 as having “NO ANNUAL FEE.”

It is noted that advertisements presented on the underside of a page marker and its associated underlying portion of release sheet can be arranged to create a mirror image or reverse mirror image effect when the page marker is peeled from the release sheet. In this way, the advertising impact on the reader is enhanced.

It is further noted that the reverse side 16b of release sheet 16 can also include advertising thereon. In this way, advertising may be presented on three or four surfaces provided by a two-sided sheet, thereby enhancing the utility and availability of advertising space.

In use, page markers 22 are individually peeled away from underlying release sheet 16 when desired, and can be used by a reader to mark a page of interest in magazine 12 for later reference. In peeling a page marker 22 from sheet 10, any advertising printed on either or both the underside of the marker and the underlying portion of top surface 16a of release sheet 16 is exposed. It should be appreciated that the advertising impact is greater when related or corresponding advertisements are presented on both the underside of the marker and the underlying release sheet in accordance with the preferred embodiment of the present invention.

The advertising utility does not end when a page marker 22 is peeled from sheet 10. Any message and/or advertising on either surface of the page marker is highly visible when the marker is properly used to mark a page in magazine 12 for later reference. Any advertising on the exposed portion of the release sheet as well as on the back side of the sheet is visible whenever sheet 10 is viewed by a reader.

As depicted in FIGS. 7 and 8, adhesive 15 employed to removably adhere a page marker 22 to sheet 10 also serves to removably adhere the marker to a page in magazine 12 for later reference. Because adhesive 15 is preferably not coated over the entire undersurface of page marker 22 (see FIG. 6) leaving the adhesive-free portion 17, when applied properly to an outer edge (e.g., edge 18) of a page of interest in magazine 12, the adhesive-free portion 17 of page marker 22 will visibly extend beyond such outer edge. Any advertisement printed on the underside of page marker 22 will be either entirely or partially visible to the reader whether or not magazine 12 is open to the marked page. Similarly, any message printed on the top surface of the page marker will also be visible.

It should be appreciated that message 26 printed on page marker 22 can serve as an indicator to the reader of magazine 12 of the relative level of interest that the marked page has for the reader. For example, a message 26 with the recitation “YES!” printed thereon (as depicted in FIG. 7) indicates that the marked page is of greater interest to the reader than is a page tagged with a page marker bearing a “MAYBE?” message (as shown in FIGS. 2 and 4). Further, the advertising provided under a “YES!” message can be different than the advertising provided under a “MAYBE?” message.

It should also be understood that messages 26 printed on page markers 22 can be varied to suit any desired editorial purpose, and thus can serve to put any advertising in various contexts.

Desirably, adhesive 15 is formulated to avoid any detrimental impact on any inks used in printing advertising or other messages on page markers 22 and release sheet 16 (e.g., by a four color process or other conventional printing process). Similarly, it is desirable that the inks employed are of sufficient composition and density to yield a clear and legible presentation through adhesive 15. In addition, the adhesive 15 is preferably sticky enough to allow the removal and repositioning of page markers 22, yet prevent damage to the underlying page from which it is removed or to which it is adhered.

In accordance with the foregoing, the present invention provides a unique and high impact advertising tool for print media in which advertising space is highly utilized and competition to capture the attention of the consumer is fierce.

It will thus be seen that the objects set forth above, among those made apparent from the preceding description, are efficiently attained and, since certain changes may be made in carrying out the above method and in the constructions set forth for the apparatus without departing from the spirit and scope of the invention, it is intended that all matter contained in the above description and shown in the accompanying drawings shall be interpreted as illustrative and not in a limiting sense.

It is also to be understood that the following claims are intended to cover all of the generic and specific features of the invention herein described, and all statements of the scope of the invention which, as a matter of language, might be said to fall therebetween.

What is claimed is:

1. A print media advertising apparatus comprising a printed publication including a plurality of pages bound together, a sheet bound in said printed publication including an overlay portion and an opposing release portion, said overlay and release portions each having a top surface and a bottom surface, an adhesive selectively provided on said bottom surface of said overlay portion to allow said overlay portion to be adhered to said top surface of said release portion, said overlay portion including at least one pre-cut section defining a removable page marker, a first advertisement printed on said bottom surface of said at least one pre-cut section of said overlay portion, and a second advertisement printed on said top surface of said release portion underlying said at least one pre-cut section of said overlay portion, said first and second advertisements having a preselected associative relationship.

2. The print media advertising apparatus of claim 1, wherein said printed publication is a magazine.

3. The print media advertising apparatus of claim 1, wherein said overlay portion and said release portion are formed from a single sheet folded such that said bottom surface of said overlay portion opposes said top surface of said release portion.

4. The print media advertising apparatus of claim 1, wherein said overlay portion and said release portion are formed from different sheet stock.

5. The print media advertising apparatus of claim 4, wherein each of said different sheet stock forming said overlay portion and said release portion are coupled to form a single sheet having a common outer edge thereof opposite the binding of said printed publication.

6. The print media advertising apparatus of claim 1, wherein the appearance of said first advertisement is substantially the same as the appearance of said second advertisement.

7. The print media advertising apparatus of claim 6, wherein said first and second advertisements are mirror images of one another.

8. The print media advertising apparatus of claim 6, wherein said first and second advertisements are reverse mirror images of one another.

9. The print media advertising apparatus of claim 1, wherein the content of said first advertisement is one of directly or indirectly related to the content of said second advertisement.

10. The print media advertising apparatus of claim 1, further comprising indicia printed on said top surface of said at least one pre-cut section of said overlay portion.

11. The print media advertising apparatus of claim 10, wherein said indicia printed on said top surface of said at least one pre-cut section of said overlay portion is an indicator of the relative level of interest the reader of said publication has in a particular page of said publication.

12. The print media advertising apparatus of claim 10, wherein said indicia printed on said top surface of said at least one pre-cut section of said overlay portion has a preselected associative relationship to at least one of said first and second advertisements.

13. The print media advertising apparatus of claim 1, further comprising indicia printed on said bottom surface of said release portion.

14. The print media advertising apparatus of claim 13, wherein said indicia printed on said bottom surface of said release portion has a preselected associative relationship to at least one of said first and second advertisements.

15. The print media advertising apparatus of claim 1, wherein said adhesive is suitable for removably adhering said at least one pre-cut section of said overlay portion to a page in said publication to mark said page for later reference after said at least one pre-cut portion has been removed from said overlay portion and said release portion.

16. The print media advertising apparatus of claim 15, wherein said adhesive is formulated to avoid any detrimental impact to said page in said publication.

17. The print media advertising apparatus of claim 1, wherein said adhesive is formulated to avoid any detrimental impact to said first and second advertisements.

18. The print media advertising apparatus of claim 1, wherein said adhesive is provided over only a portion of said bottom surface of said at least one pre-cut section of said overlay portion leaving an adhesive-free portion.

19. The print media advertising apparatus of claim 18, wherein said adhesive-free portion forms a grip region for grasping said at least one pre-cut section of said overlay portion.

20. The print media advertising apparatus of claim 1, wherein said adhesive has a relatively low adhesion property.

21. The print media advertising apparatus of claim 1, wherein said overlay portion includes a plurality of pre-cut sections each defining a removable page marker.

22. The print media advertising apparatus of claim 21, wherein said pre-cut sections are spaced apart on said overlay portion.

23. The print media advertising apparatus of claim 21, wherein the bottom surfaces of one of said pre-cut sections and another of said pre-cut sections include different advertisements.

24. The print media advertising apparatus of claim 23, wherein said different advertisements are related.

25. The print media advertising apparatus of claim 23, wherein said top surface of said release layer includes a plurality of advertisements, each advertisement being positioned to correspond to the location of one of said pre-cut sections.

26. In a printed publication having a plurality of pages bound together, a page marker sheet comprising an upper section and an opposing lower section, said upper and lower sections each having a top surface and a bottom surface, an adhesive material selectively provided on said bottom surface of said upper section, said upper section including at least one pre-cut portion defining a removable page marker, and advertisements selectively printed on said bottom surface of said at least one pre-cut portion of said upper section and on said top surface of said lower section underlying said at least one pre-cut portion of said upper section, said advertisements having a preselected associative relationship.

27. The page marker sheet of claim 26, wherein said upper section and said lower section are formed from a single sheet folded such that said bottom surface of said upper section opposes said top surface of said lower section.

28. The page marker sheet of claim 26, wherein said upper section and said lower section are formed from different sheet stock.

29. The page marker sheet of claim 28, wherein each of said different sheet stock forming said upper section and said lower section are coupled to form a single sheet.

30. The page marker sheet of claim 26, wherein said advertisements printed on said bottom surface of said at least one pre-cut portion of said upper section and on said top surface of said lower section underlying said at least one pre-cut portion of said upper section are substantially the same in appearance.

31. The page marker sheet of claim 30, wherein said advertisements printed on said bottom surface of said at least one pre-cut portion of said upper section and on said top surface of said lower section underlying said at least one pre-cut portion of said upper section are mirror images of one another.

32. The page marker sheet of claim 30, wherein said advertisements printed on said bottom surface of said at least one pre-cut portion of said upper section and on said top surface of said lower section underlying said at least one pre-cut portion of said upper section are reverse mirror images of one another.

33. The page marker sheet of claim 26, wherein the content of said advertisements printed on said bottom surface of said at least one pre-cut portion of said upper section and on said top surface of said lower section underlying said at least one pre-cut portion of said upper section is one of directly or indirectly related.

34. The page marker sheet of claim 26, further comprising indicia printed on said top surface of said at least one pre-cut portion of said upper section.

35. The page marker sheet of claim 34, wherein said indicia printed on said top surface of said at least one pre-cut portion of said upper section is an indicator of the relative level of interest a reader of a publication has in a particular page of said publication.

36. The page marker sheet of claim 34, wherein said indicia printed on said top surface of said at least one pre-cut portion of said upper section has a preselected associative relationship to at least one of said advertisements printed on said bottom surface of said at least one pre-cut portion of said upper section and on said top surface of said lower section underlying said at least one pre-cut portion of said upper section.

37. The page marker sheet of claim 26, further comprising indicia printed on said bottom surface of said lower section.

38. The page marker sheet of claim 37, wherein said indicia printed on said bottom surface of said lower section has a preselected associative relationship to at least one of said advertisements printed on said bottom surface of said at least one pre-cut portion of said upper section and on said top surface of said lower section underlying said at least one pre-cut portion of said upper section.

39. The page marker sheet of claim 26, wherein said adhesive material is suitable for removably adhering said at least one pre-cut portion of said upper section to a page in a publication to mark said page for later reference after said at least one pre-cut portion has been removed from said upper section and said lower section.

40. The page marker sheet of claim 39, wherein said adhesive material is formulated to avoid any detrimental impact to said page in said publication.

41. The page marker sheet of claim 26, wherein said adhesive material is formulated to avoid any detrimental impact to said advertisements.

42. The page marker sheet of claim 26, wherein said adhesive material is provided over only a portion of said bottom surface of said at least one pre-cut portion of said upper section leaving an adhesive-free portion.

43. The page marker sheet of claim 42, wherein said adhesive-free portion forms a grip region for grasping said at least one pre-cut portion of said upper section.

44. The page marker sheet of claim 26, wherein said adhesive material has a relatively low adhesion property.

45. The page marker sheet of claim 26, wherein said upper section includes a plurality of pre-cut portions each defining a removable page marker.

46. The page marker sheet of claim 45, wherein said pre-cut portions are spaced apart on said upper section.

47. The page marker sheet of claim 45, wherein the bottom surfaces of one of said pre-cut portions and another of said pre-cut portions include different advertisements.

48. The page marker sheet of claim 47, wherein said different advertisements are related.

49. The page marker sheet of claim 45, wherein said top surface of said lower section includes a plurality of advertisements, each advertisement being positioned to correspond to the location of one of said pre-cut portions.

50. A publication comprising a plurality of pages bound together, a sheet including an overlay portion and an opposing release portion bound with said pages, said overlay and release portions each having a top surface and a bottom surface, an adhesive selectively provided on said bottom surface of said overlay portion to allow said overlay portion to be adhered to said top surface of said release portion, said overlay portion including at least one precut section defining a removable page marker, and advertisements selectively printed on said bottom surface of said at least one pre-cut section of said overlay portion and on said top surface of said release portion underlying said at least one pre-cut section of said overlay portion, said advertisements having a preselected associative relationship.

51. The publication of claim 50, wherein said overlay portion and said release portion are formed from a single sheet folded such that said bottom surface of said overlay portion opposes said top surface of said release portion.

52. The publication of claim 50, wherein said overlay portion and said release portion are formed from different sheet stock.

53. The publication of claim 52, wherein each of said different sheet stock forming said overlay portion and said release portion are coupled to form a single sheet.

54. The publication of claim 50, wherein said advertisements printed on said bottom surface of said at least one pre-cut section of said overlay portion and on said top surface of said release portion underlying said at least one pre-cut section of said overlay portion are substantially the same in appearance.

55. The publication of claim 54, wherein said advertisements printed on said bottom surface of said at least one pre-cut section of said overlay portion and on said top surface of said release portion underlying said at least one pre-cut section of said overlay portion are mirror images of one another.

56. The publication of claim 54, wherein said advertisements printed on said bottom surface of said at least one pre-cut section of said overlay portion and on said top surface of said release portion underlying said at least one pre-cut section of said overlay portion are reverse mirror images of one another.

57. The publication of claim 50, wherein the content of said advertisements printed on said bottom surface of said at least one pre-cut section of said overlay portion and on said top surface of said release portion underlying said at least one pre-cut section of said overlay portion is one of directly or indirectly related.

58. The publication of claim 50, further comprising indicia printed on said top surface of said at least one pre-cut section of said overlay portion.

59. The publication of claim 58, wherein said indicia printed on said top surface of said at least one pre-cut section of said overlay portion is an indicator of the relative level of interest a reader of a publication has in a particular page of said publication.

60. The publication of claim 58, wherein said indicia printed on said top surface of said at least one pre-cut section of said overlay portion has a preselected associative relationship to at least one of said advertisements printed on said bottom surface of said at least one pre-cut section of said overlay portion and on said top surface of said release portion underlying said at least one pre-cut section of said overlay portion.

61. The publication of claim 50, further comprising indicia printed on said bottom surface of said release portion.

62. The publication of claim 61, wherein said indicia printed on said bottom surface of said release portion has a preselected associative relationship to at least one of said advertisements printed on said bottom surface of said at least one pre-cut section of said overlay portion and on said top surface of said release portion underlying said at least one pre-cut section of said overlay portion.

63. The publication of claim 50, wherein said adhesive is suitable for removably adhering said at least one pre-cut section of said overlay portion to one of said pages to mark said page for later reference after said at least one pre-cut portion has been removed from said overlay portion and said release portion.

64. The publication of claim 63, wherein said adhesive is formulated to avoid any detrimental impact to said page.

65. The publication of claim 50, wherein said adhesive is formulated to avoid any detrimental impact to said advertisements.

66. The publication of claim 50, wherein said adhesive is provided over only a portion of said bottom surface of said at least one pre-cut section of said overlay portion leaving an adhesive-free portion.

67. The publication of claim 66, wherein said adhesive-free portion forms a grip region for grasping said at least one pre-cut section of said overlay portion.

68. The publication of claim 50, wherein said adhesive has a relatively low adhesion property.

69. The publication of claim 50, wherein said overlay portion includes a plurality of pre-cut sections each defining a removable page marker.

70. The publication of claim 69, wherein said pre-cut sections are spaced apart on said overlay portion.

71. The publication of claim 69, wherein the bottom surfaces of one of said pre-cut sections and another of said pre-cut sections include different advertisements.

72. The publication of claim 71, wherein said different advertisements are related.

73. The publication of claim 71, wherein said top surface of said release layer includes a plurality of advertisements, each advertisement being positioned to correspond to the location of one of said pre-cut sections.

74. A method of advertising in a magazine comprising the steps of providing at least one sheet of removable and repositionable page markers, said page markers including an overlay portion adhered to an opposing release portion, said overlay portion including at least one pre-cut section releasably attached thereto defining a removable page marker, a bottom surface of said at least one pre-cut section including a portion having an adhesive coating and an adhesive-free portion, and selectively providing advertisements printed on said bottom surface of said at least one pre-cut section of said overlay portion and on a top surface of said release portion underlying said at least one pre-cut section of said overlay portion, said advertisements having a preselected associative relationship, whereby said at least one pre-cut section of said overlay portion is removed from said overlay portion and said release portion thereby exposing said advertisements, and said at least one pre-cut section of said overlay portion is removably adhered to a page of a magazine to mark said page for later reference.

75. The advertising method of claim 74, wherein removal of said at least one pre-cut section of said overlay portion from said overlay portion and said release portion involves pulling said adhesive-free portion.

76. The advertising method of claim 74, wherein said advertisements printed on said bottom surface of said at least one pre-cut section of said overlay portion and on said top surface of said release portion underlying said at least one pre-cut section of said overlay portion are substantially the same in appearance.

77. The advertising method of claim 76, wherein said advertisements printed on said bottom surface of said at least one pre-cut section of said overlay portion and on said top surface of said release portion underlying said at least one pre-cut section of said overlay portion are mirror images of one another.

78. The advertising method of claim 76, wherein said advertisements printed on said bottom surface of said at least one pre-cut section of said overlay portion and on said top surface of said release portion underlying said at least one pre-cut section of said overlay portion are reverse mirror images of one another.

79. The advertising method of claim 74, wherein the content of said advertisements printed on said bottom surface of said at least one pre-cut section of said overlay portion and on said top surface of said release portion underlying said at least one pre-cut section of said overlay portion is one of directly or indirectly related.

80. The advertising method of claim 74, further comprising the step of providing indicia on a top surface of said at least one pre-cut section of said overlay portion.

81. The advertising method of claim 80, wherein said indicia printed on said top surface of said at least one pre-cut section of said overlay portion is an indicator of the relative level of interest a reader of a publication has in a particular page of said publication.

82. The advertising method of claim 80, wherein said indicia printed on said top surface of said at least one pre-cut section of said overlay portion has a preselected associative relationship to at least one of said advertisements printed on said bottom surface of said at least one pre-cut section of said overlay portion and on said top surface of said release portion underlying said at least one pre-cut section of said overlay portion.

83. The advertising method of claim 74, further comprising the step of providing indicia on a bottom surface of said release portion.

84. The advertising method of claim 83, wherein said indicia printed on said bottom surface of said release portion has a preselected associative relationship to at least one of said advertisements printed on said bottom surface of said at least one pre-cut section of said overlay portion and on said top surface of said release portion underlying said at least one pre-cut section of said overlay portion.

85. A sheet of page markers for use in a publication comprising an upper section and an opposing lower section, said upper and lower sections each having a top surface and a bottom surface, an adhesive material selectively provided on said bottom surface of said upper section, said upper section including a plurality of pre-cut portions defining removable page markers, and corresponding advertisements selectively printed on said bottom surfaces of selected ones of said pre-cut portions of said upper section and on said top surface of said lower section underlying selected ones of said pre-cut portions of said upper section, said corresponding advertisements having a preselected associative relationship.

86. The sheet of page markers of claim 85, wherein said upper section and said lower section are formed from a single sheet folded such that said bottom surface of said upper section opposes said top surface of said lower section.

87. The sheet of page markers of claim 85, wherein said upper section and said lower section are formed from different sheet stock.

88. The sheet of page markers of claim 87, wherein each of said different sheet stock forming said upper section and said lower section are coupled to form a single sheet.

89. The sheet of page markers of claim 85, wherein said advertisements printed on said bottom surfaces of said pre-cut portions of said upper section and on said top surface of said lower section underlying said pre-cut portions of said upper section are substantially the same in appearance.

90. The sheet of page markers of claim 89, wherein said advertisements printed on said bottom surfaces of said pre-cut portions of said upper section and on said top surface of said lower section underlying said pre-cut portions of said upper section are mirror images of one another.

91. The sheet of page markers of claim 89, wherein said advertisements printed on said bottom surfaces of said pre-cut portions of said upper section and on said top surface of said lower section underlying said pre-cut portions of said upper section are reverse mirror images of one another.

92. The sheet of page markers of claim 85, wherein the content of said advertisements printed on said bottom surfaces of said pre-cut portions of said upper section and on said top surface of said lower section underlying said pre-cut portions of said upper section is one of directly or indirectly related.

93. The sheet of page markers of claim 85, further comprising indicia printed on said top surfaces of said pre-cut portions of said upper section.

94. The sheet of page markers of claim 93, wherein said indicia printed on said top surfaces of said pre-cut portions of said upper section is an indicator of the relative level of interest a reader of a publication has in a particular page of said publication.

95. The sheet of page markers of claim 93, wherein said indicia printed on said top surfaces of said pre-cut portions of said upper section has a preselected associative relationship to at least one of said advertisements printed on said bottom surfaces of said pre-cut portions of said upper section and on said top surface of said lower section underlying said precut portions of said upper section.

96. The sheet of page markers of claim 85, further comprising indicia printed on said bottom surface of said lower section.

97. The sheet of page markers of claim 96, wherein said indicia printed on said bottom surface of said lower section has a preselected associative relationship to at least one of said advertisements printed on said bottom surfaces of said pre-cut portions of said upper section and on said top surface of said lower section underlying said pre-cut portions of said upper section.

98. The sheet of page markers of claim 85, wherein said adhesive material is suitable for removably adhering at least one of said pre-cut portions of said upper section to a page in a publication to mark said page for later reference after said at least one of said pre-cut portions has been removed from said upper section and said lower section.

99. The sheet of page markers of claim 98, wherein said adhesive material is formulated to avoid any detrimental impact to said page in said publication.

100. The sheet of page markers of claim 85, wherein said adhesive material is formulated to avoid any detrimental impact to said advertisements.

101. The sheet of page markers of claim 85, wherein said adhesive material is provided over only a portion of said bottom surface of each of said pre-cut portions of said upper section leaving an adhesive-free portion.

102. The sheet of page markers of claim 101, wherein said adhesive-free portion forms a grip region for grasping each of said pre-cut portions of said upper section.

103. The sheet of page markers of claim 85, wherein said adhesive material has a relatively low adhesion property.

104. The sheet of page markers of claim 85, wherein said pre-cut portions are spaced apart on said upper section.
